(19) United States
(12) Patent Application Publication
(10) Pub. No.: US 2007/0104514 A1
(43) Pub. Date: May 10, 2007

(54) Image forming method and printing method thereof

(75) Inventors: In-sik Seo, Suwon-si (KR); Myung-woo Yang, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/501,702

(22) Filed: Aug. 10, 2006

(30) Foreign Application Priority Data
Nov. 4, 2005 (KR) 2005-105578

(51) Int. Cl. G03G 15/01

(52) U.S. Cl. 399/223

(57) ABSTRACT

An image forming apparatus, including a first image forming unit, including a first photoconductor and a first developing device that develops an image by supplying toner onto an electrostatic latent image formed on the first photoconductor, a second image forming unit, including a second photoconductor and a second developing device that develops an image by supplying toner onto an electrostatic latent image formed on the second photoconductor, and a control unit to control operations of the second image forming unit, so that, when the first image forming unit is not installed in the image forming apparatus, the image is printed in response to desired image data by an operation of the second image forming unit.

### CROSS-REFERENCE TO RELATED APPLICATION

This application claims the benefit of Korean Patent Application No. 2005-105578, filed on Nov. 4, 2005, in the Korean Intellectual Property Office, the disclosure of which is incorporated herein in its entirety by reference.

### BACKGROUND OF THE INVENTION

1. Field of the Invention

An aspect of the present invention relates to an image forming apparatus, and, more particularly, to an image forming apparatus that prints a mono-chromatic image regardless of a state of installation of a color developing unit and has an improved printing speed when printing a color image and a printing method thereof.

2. Description of the Related Art

Generally, a common image forming apparatus has a charging process in which the surface of a photoconductor is charged to have a predetermined electric potential, an exposing process in which an electrostatic latent image is formed by illuminating light onto the surface of the photoconductor by the use of a light scanning unit such as a laser scanning unit (LSU), a developing process in which the electrostatic latent image formed on the surface of the photoconductor is developed into a toner image by supplying a toner, or a development material, onto the electrostatic latent image formed on the surface of the photoconductor, a feeding process in which a printing medium (i.e., paper, transparency, etc.) loaded on a feeding cassette is fed along a transfer path, a transfer process in which the toner image formed on the photoconductor is transferred onto the printing medium, a fusing process in which the toner image that is transferred onto the printing medium is fused onto the printing medium by an application of heat and pressure, and a discharging process in which the printing medium, having been subjected to the fusing process, is discharged from the image forming apparatus.

In the image forming apparatus, which forms an image onto a printing medium by the aforementioned process, toner of a developing unit is transferred onto a photoconductor by a potential difference between the developing unit and the photoconductor. According to this method, either a selected developing unit is operated or four developing units are sequentially operated.

FIG. 1 is a schematic sectional view of a conventional image forming apparatus. As shown in FIG. 1, the image forming apparatus includes a photoconductive drum 10, a charger 11 which charges the photoconductive drum 10, a laser scanning unit (LSU) 12 as a light scanning unit which forms an electrostatic latent image by illuminating light on the photoconductive drum 10, a developing unit 13 which develops the electrostatic latent image into four toner images of black, yellow, magenta, and cyan, a transfer belt 14 which sequentially superimposes the toner images of the four colors developed onto the photoconductive drum 10, a first transfer roller 14a which transfers the toner images developed on the photoconductive drum 10 to the transfer belt 14, a second transfer roller 14b which transfers an image, in which the four colors are superimposed, on the transfer belt 14 onto a printing medium, and a fusing unit 15 which fuses the image onto the printing medium by applying heat and pressure thereon.

In addition, developing rollers 13a-K, 13a-Y, 13a-M, and 13a-C of four developing units 13-K, 13-Y, 13-M, and 13-C provided in the developing unit 13 are separated from the photoconductive drum 10 by a predetermined gap, and developing bias voltages are sequentially applied thereto to form the electrostatic latent image on the photoconductive drum 10. The reference numeral 16 denotes a feeding cassette, 17 denotes a photoconductor cleaning blade, 18 denotes a charge removing unit, and 19 denotes a transfer path that the printing medium is transferred along.

In the aforementioned configuration, image forming operations are carried out as follows. First, the charger 11 charges the photoconductive drum 10. Then, the LSU 12 illuminates light thereto to form an electrostatic latent image of a first color image to be developed. For example, if black corresponds to the first color image to be developed, a predetermined bias voltage is applied to the black developing roller 13a-K, the developing roller 13a-K is operated by a developing unit driving motor (not shown), and a toner T attached to the outer circumferential surface thereof is transferred to an electrostatic latent image portion of the photoconductive drum 10 which is in contact therewith. The black image developed, as mentioned above, is then transferred onto the transfer belt 14 through a first transfer nip N1. Next, an electrostatic latent image of a second color is formed by the charging and exposing processes of the photoconductive drum 10. For example, if yellow corresponds to the second color image to be developed, a predetermined bias voltage is applied to the yellow developing roller 13a-Y, and the developing roller 13a-Y is operated to form an electrostatic latent image of the photoconductive drum 10. The yellow image developed, as mentioned above, is transferred onto the transfer belt 14 superimposed on the black image. In the same manner, magenta and cyan images are developed and transferred, and, finally, an image having a desired color is formed onto the transfer belt 14. Next, the color image is transferred onto a printing medium supplied to a second transfer nip N2 located between the transfer belt 14 and the second transfer belt 14b and is completely fused on the printing medium by an application of heat and pressure while passing the fusing unit 15.

In a conventional image forming apparatus having the aforementioned configuration, when printing a color image, a toner image on the photoconductive drum 10 is transferred as many as four superimposing times and is then again transferred onto the printing medium. Thus, a printing speed of a color image is approximately a quarter of a printing speed of a mono-chromatic (black and white) image.

An image forming apparatus to print an image using two photoconductors to improve this problem is disclosed in Japanese Unexamined Patent Application Publication No. 1992-204871. According to this publication, two photoconductors and a plurality of developing units for respective photoconductors are used when printing an image. However, the aforementioned apparatuses are selectively operated only when all developing cartridges are installed. That is, when a part of the development units are not installed, a system error is indicated and an image cannot be printed.

### SUMMARY OF THE INVENTION

An aspect of the present invention provides an image forming apparatus in which a first image forming unit may be selectively installed therein, so that an image forming operation may be performed by a second image forming unit even if the first image forming unit is not installed. As such, a user may selectively purchase a mono-chromatic image forming unit or a color image forming unit.

According to an aspect of the present invention, there is provided an image forming apparatus, including a first image forming unit, including a first photoconductor and a first developing device that develops an image by supplying toner onto an electrostatic latent image formed on the first photoconductor, a second image forming unit, including a second photoconductor and a second developing device that develops an image by supplying toner onto an electrostatic latent image formed on the second photoconductor, and a control unit to control operations of the second image forming unit, so that, when the first image forming unit is not installed in the image forming apparatus, the image is printed in response to desired image data by an operation of the second image forming unit.

In the aforementioned aspect of the image forming apparatus, the first developing device may comprise a plurality of developing units in which toners to develop a color image are stored.

In addition, the second developing device may comprise a developing unit in which a black toner to develop a mono-chromatic image is stored.

In addition, the first developing device may comprise three developing units to store cyan, magenta, and yellow toner, and the second developing device may comprise a developing unit to store black toner, the second developing device being detachably disposed in the second image forming unit, irrespective of an installation state of the first developing device.

In addition, the image forming apparatus may further comprise first and second transfer units which face the first and second photoconductors and which are disposed at the opposite side of the surface where the first and second photoconductor face.

In addition, the image forming apparatus may further comprise a light scanning unit which forms the electrostatic latent image on an outer circumferential surface of the first and second photoconductors by illuminating light corresponding to image data in response to a computer signal.

In addition, the image forming apparatus may further comprise an intermediate transfer device which faces the first and second photoconductors and to which a toner image developed onto the first and second photoconductors is transferred.

In addition, the first and second image forming units may be disposed such that the toner image developed onto the first and second photoconductors is transferred onto a printing medium that is transferred along a predetermined path.

According to another aspect of the present invention, there is provided an image forming apparatus comprising a first image forming unit, including a first photoconductor and a first developing device that develops an image by supplying a toner onto an electrostatic latent image formed on the first photoconductor, a second image forming unit, including a second photoconductor and a second developing device that develops an image by supplying a toner onto an electrostatic latent image formed on the second photoconductor, and a control unit to control operations of the first and second image forming units, so that a process speed ratio of the first and second image forming units is approximately 3:1.

In the aforementioned aspect of the image forming apparatus, the control unit may control the operations of the first and second image forming units, so that a printing speed of a mono image is approximately three times faster than a printing speed of a color image.

In addition, the first developing device may comprise three developing units to store cyan, magenta, and yellow toner, and the second developing device comprises a developing unit to store black toner, the second developing device being detachably disposed in the second image forming unit, irrespective of an installation state of the first developing device.

In addition, the control unit may control the operations of the first and second image forming units, so that a black toner image is transferred onto an intermediate transfer device, while any one of toner images of cyan, magenta, and yellow are transferred onto the intermediate transfer device.

In addition, the first image forming unit and the second image forming unit may have a structure in which the second photoconductor rotates once to develop the black image, while the first photoconductor rotates three times to superimposedly develop the cyan, magenta, and yellow images.

According to another aspect of the present invention, there is provided a printing method to operate an image forming apparatus having a first image forming unit which includes a first developing device developing a color image by supplying a toner onto the first photoconductor and a second image forming unit which includes a second developing device developing a mono-chromatic image by supplying a black toner onto the second photoconductor; wherein, when printing the color image, a toner image is transferred onto a recording medium by an operation of the first and second image forming units, whereas when printing the mono-chromatic image, the toner image is transferred onto the recording medium by operating the second image forming unit, even when the first image forming unit is not installed.

In the aforementioned aspect of the printing method of an image forming apparatus, the recording medium may be a printing medium.

In addition, the recording medium may be an intermediate transfer device.

According to another aspect of the present invention, there is provided a printing method to operate an image forming apparatus having a first image forming unit which includes a first developing device developing a color image by supplying a toner onto the first photoconductor and a second image forming unit which includes a second developing device developing a mono image by supplying a black toner onto the second photoconductor; wherein a process speed ratio of the first and second image forming units is approximately 3:1.

In the aforementioned aspect of the printing method of an image forming apparatus, the operations of the first and second image forming units may be controlled so that a printing speed of a mono-chromatic image is approximately three times faster than a printing speed of a color image.

In addition, the first developing device may comprise three developing units to store cyan, magenta, and yellow toner, and the second developing device may comprise a developing unit to store black toner, the second developing device being detachably disposed in the second image forming unit, irrespective of an installation state of the first developing device.

In addition, the first image forming unit and the second image forming unit may have a structure in which the second photoconductor rotates once time to develop the black image, while the first photoconductor rotates three times to superimposedly develop the cyan, magenta, and yellow images.

Additional and/or other aspects and advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic sectional view of a conventional image forming apparatus;

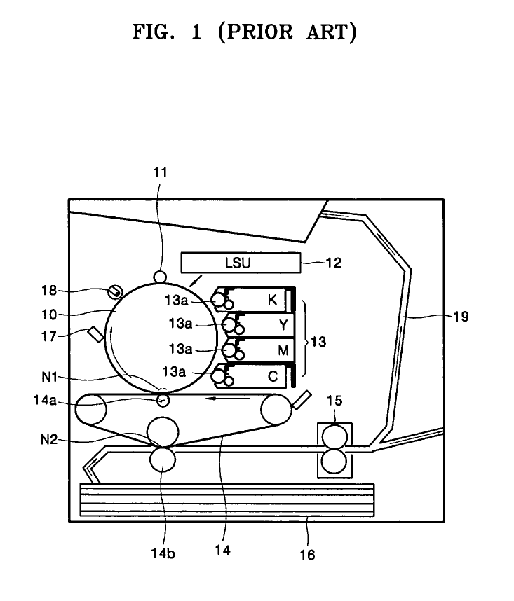

FIG. 2 is a sectional view of an image forming apparatus according to an embodiment of the present invention;

FIG. 3 is a perspective view of a first photoconductive unit of FIG. 2;

FIG. 4 is a perspective view of an intermediate transfer device of FIG. 2; and

FIG. 5 is a schematic sectional view of first and second image forming units and the intermediate transfer device of FIG. 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

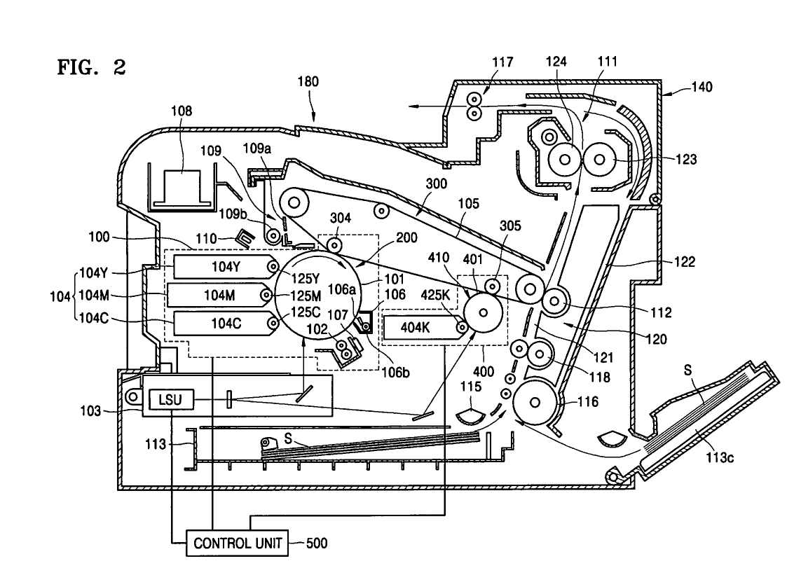

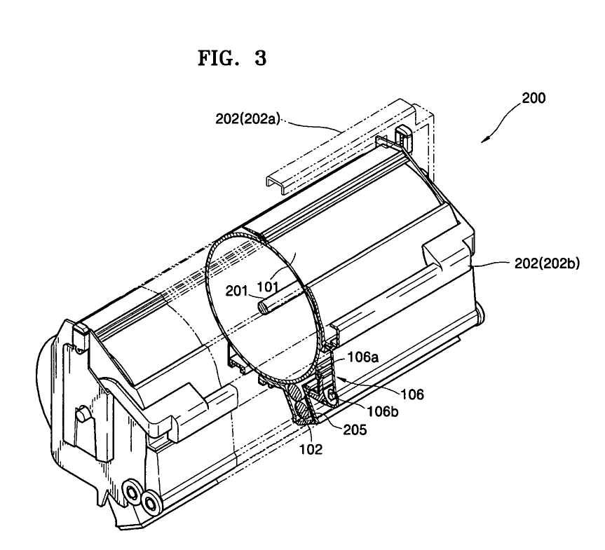

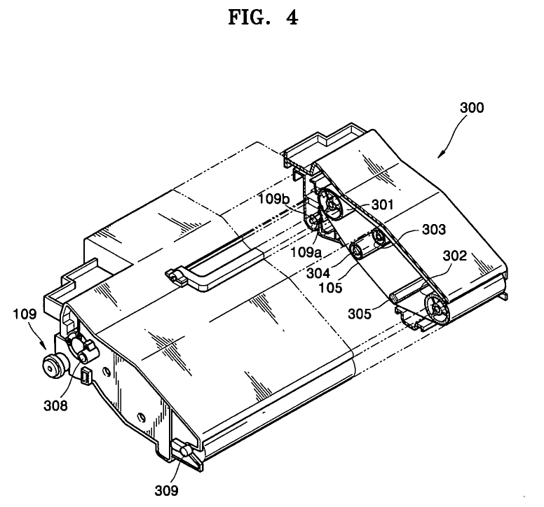

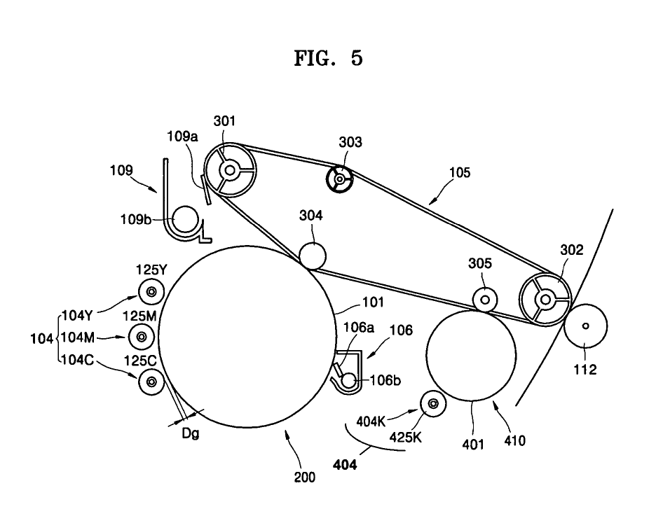

FIG. 2 is a sectional view of an image forming apparatus according to an embodiment of the present invention, FIG. 3 is a perspective view of a first photoconductive unit of FIG. 2, and FIG. 4 is a perspective view of an intermediate transfer device of FIG. 2. In addition, FIG. 5 is a schematic sectional view of first and second image forming units and the intermediate transfer device of FIG. 2. Since configurations and operations of a second photoconductive unit are similar as in the first photoconductive unit of the FIG. 3, a detailed description for this will be omitted.

As shown in FIG. 2, a first image forming unit 100, a second image forming unit 400, a light scanning unit 103, an intermediate transfer device 300, and a control unit 500, which controls operations of the respective elements, are included in a main frame 140 of the image forming apparatus. Here, the first image forming unit 100 includes a first photoconductor 101 and a first developing device 104 which performs a development of an image by supplying toner to the first photoconductor 101. Similarly, the second image forming unit 400 includes a second photoconductor 401 and a second developing device 404 which performs a development of an image by supplying toner to the second photoconductor 401. The second developing device 404 stores black toner which is used for printing a mono-chromatic (i.e., a black and white) image. In addition, the first image forming unit 100 and the second image forming unit 400 are disposed inside of the main frame 140 as detachable cartridges. In alternate embodiments of the invention, the first developing device 104 and the second developing device 404 are disposed inside of the main frame 140 as detachable cartridges.

In the first photoconductor 101, a photoconductive material layer is coated on the outer circumferential surface of the cylindrical metal drum by various methods, such as a deposition method, and a portion of the outer circumferential surface thereof is exposed. The first photoconductor 101 rotates in a predetermined direction, and an electrostatic latent image corresponding to a desired image is formed on the outer circumferential surface thereof by the use of light illuminated by the light scanning unit 103.

A charging roller 102 is an example of a charger which charges the first photoconductor 101 to have a uniform electric potential. The charging roller 102 rotates in contact or non-contact with the outer circumferential surface of the first photoconductor 101 and supplies an electric charge thereto so that the outer circumferential surface of the first photoconductor 101 is provided with a uniform electric potential. A charging bias voltage is then applied to the charging roller 102 in order to charge the outer circumferential surface of the first photoconductor 101 to have a uniform electric potential. According to an embodiment of the invention, a corona discharger (not shown) may be used instead of the charging roller 102, although, it is understood that other charging devices may be used.

The light scanning unit 103 is disposed to face downward with respect to the first photoconductor 101 and the second photoconductor 401 and forms an electrostatic latent image on the outer circumferential surface of the first photoconductor 101 and the second photoconductor 401 by illuminating light corresponding to image data onto the first photoconductor 101 and the second photoconductor 401 which are charged to have a uniform electric potential in response to a computer signal. The light scanning unit 103 includes a light source (now shown) which illuminates a laser beam and a beam deflector which deflects the laser beam. The beam deflector may be a polygon mirror (not shown) which illuminates light while being rotated by a driving source. Meanwhile, a hologram disc (not shown) which deflects light by diffracting the light using a hologram pattern may be used instead of the polygon mirror (not shown). A laser scanning unit (LSU) which normally uses a laser diode as a light source is used as the light scanning unit 103. In the present invention, the electrostatic latent image is formed on the outer circumferential surface of the two photoconductors 101 and 401 using one light scanning unit 103.

For color printing operations, in embodiments of the invention, the first developing device 104 has black toner stored in the second developing device 404 and at least one of other colored toners. Hereinafter, a case in which the first developing device 104 includes three developing units 104C, 104M, and 104Y storing cyan, magenta, and yellow toner, and in which the second developing device 404 includes one developing unit 404K storing black toner and one developing roller 425K, will be described.

The first developing device 104 includes a plurality of developing units in which toners to develop a color image are stored. In the present invention, the first developing device 104 includes three developing units 104C, 104M, and 104Y in which cyan, magenta, and yellow colored toners are stored. Here, the three developing units 104C, 104M, and 104Y are placed in the first developing device 104, which is a single cartridge and which is detachable from the main frame 140. The developing units 104C, 104M, and 104Y respectively include developing rollers 125C, 125M, and 125Y to form a toner image by supplying the toners onto the electrostatic latent image form on the first photoconductor 101. The developing units 104C, 104M, and 104Y are replaced when the toners stored therein are used up.

The developing rollers 125C, 125M, and 125Y cause the toners stored in the developing units 104C, 104M, and 104Y to be attached onto the outer circumferential surfaces of the developing units 104C, 104M, and 104Yto be positioned to be supplied to the first photoconductor 101. The developing rollers 125C, 125M, and 125Y store solid powder type toners and develop the toner image by supplying the toners onto the electrostatic latent image formed on the first photoconductor 101. A developing bias voltage to cause the toners to be attracted to the first photoconductor 101 is applied to the developing rollers 125C, 125M, and 125Y.

The three developing units 104C, 104M, and 104Y are disposed such that respective developing rollers 125C, 125M, and 125Y are separated from the outer circumferential surface of the first photoconductor 101 by a predetermined gap, or a development gap Dg. A force directed from the first photoconductor 101 to respective developing rollers 125C, 125M, and 125Y is generated by the electric field, and charged toners are reciprocally vibrated in a development area formed in the development gap Dg and are transferred to be developed. A length of the development gap Dg is, in accordance with embodiments of the invention, approximately tens to hundreds of microns.

The second developing device 404 is disposed in a detachable manner, irrespective of a state of an installation of first developing device 104. That is, regardless of whether the first developing device 104 is installed in the main frame 140, the second developing device 404 may be operated. Here, it is understood that the second developing device 404 stores only black toner.

The intermediate transfer device 300 faces the first and second photoconductors 101 and 401 and includes an intermediate transfer device 105 to which the toner image, developed on the first and second photoconductors 101 and 401, is transferred. In addition, first and second transfer units 304 and 305 facing the first and second photoconductors 101 and 401 are further provided at the other side of the surface facing the first and second photoconductors 101 and 401 of the intermediate transfer device 105. A transfer bias voltage is applied to the first and second transfer units 304 and 305 so that the toner image formed on the first and second photoconductors 101 and 401 is able to be transferred to the intermediate transfer device 105. Here, the first and second transfer units 304 and 305 include a transfer roller.

The intermediate transfer device 105 includes an intermediate transfer belt (ITB) which travels in a loop and which is supported by a plurality of rollers. Cyan, magenta, and yellow toner images, which are sequentially formed on the first photoconductor 101, and a black toner image formed on the second photoconductor 401 are sequentially transferred to the ITB. The toner images are superimposedly transferred onto the ITB and a color toner image is thereby formed. In general, the length of the ITB must be equal or greater than the length of a printing medium S (i.e., paper, a transparency, etc.) where the color toner image is finally stored.

Hereinafter, the intermediate transfer device 300 including a first photoconductive unit 200 and the intermediate transfer device 105 will be described in detail. Since configurations and operations of a second photoconductive unit 410 are similar as in the first photoconductive unit 200, a detailed description or a drawing for this will be omitted.

As shown in FIGS. 2 to 4, the first photoconductive unit 200 is disposed in the main frame 140 in a detachable manner. Meanwhile, the first photoconductive unit 200 may be incorporated with the first developing device 104. The intermediate transfer device 300 is disposed to face upwards with respect to the first photoconductive unit 200 and the second photoconductive unit 410 in a detachable manner in the main frame 140.

In the present embodiment, the developing units 104C, 104M, and 104Y are disposed such that the cyan developing unit 104C is followed by the magenta developing unit 104M which is followed by the yellow developing unit 104Y from downwards to upwards. A pre-transfer charge removing unit 110 is disposed upwards with respect to the developing unit 104Y disposed at the top. The light scanning unit 103 and a charge removing lamp 107 are disposed downwards with respect to the first photoconductive unit 200.

As shown in FIG. 3, the first photoconductive unit 200 includes the first photoconductor 101, which is rotatably disposed to a shaft 201, and a first cleaning unit 106. The first photoconductive unit 200 may further include the charging roller 102. The first photoconductive unit 200 may further include a light guiding member 205 which guides light illuminated by the charge removing lamp 107 to the first photoconductor 101. In addition, the first photoconductive unit 200 may further include a handle 202 that is rotatably disposed to the shaft 201. The handle 202 rotates towards a position 202a when the first photoconductive unit 200 is installed or removed from the main frame 140 and rotates towards a position 202b after the installation of the first photoconductive unit 200.

As shown in FIGS. 3 and 5, the first cleaning unit 106 includes a first blade 106a which scrapes waste toner remaining on the surface of the first photoconductor 101 and a first transfer device 106b which transfers the waste toner towards a waste toner storage unit (not shown). The first transfer device 106b may comprise a spiral shaped wing, and an auger which rotates in a predetermined direction to transfer the waste toner.

Referring to FIGS. 4 and 5, the intermediate transfer device 300 includes the intermediate transfer device 105, the first transfer unit 304, a plurality of supporting rollers 301, 302, and 303, the second transfer unit 305, and a second cleaning unit 109.

The intermediate transfer device 105 faces the first and second photoconductors 101 and 401 so that the toner image developed on the outer circumferential surface of the first and second photoconductors 101 and 401 is transferable from the first and second photoconductors 101 and 401 to the intermediate transfer device 105. Namely, the intermediate transfer device 105 is supported by the plurality of rollers and travels along a circular predetermined path, and the toner image developed on the outer circumferential surface of the first and second photoconductors 101 and 401 is transferred from the first and second photoconductors 101 and 401 to the intermediate transfer device 105. A polyamide belt having relatively excellent charging properties may be used for the intermediate transfer device 105, although it is understood that other charging devices may be employed.

The plurality of supporting rollers 301, 302, and 303 are disposed on the inner circumferential surface of the intermediate transfer device 105, support the intermediate transfer device 105, and rotate the intermediate transfer device 105 in a predetermined direction. The supporting roller 301 is preferably a driving roller. The supporting roller 302 disposed at the opposite side with respect to the supporting roller 301 faces a transfer roller 112.

The first and second transfer units 304 and 305 are disposed on the inner circumferential surface of the intermediate transfer device 105, so that the toner image developed on the first and second photoconductors 101 and 401 is transferred to the intermediate transfer device 105. A transfer bias voltage to transfer the toner image formed on the first photoconductor 101 to the intermediate transfer device 105 is applied to the first and second transfer units 304 and 305.

Meanwhile, a first supporting unit 308 and a second supporting unit 309 which support the intermediate transfer device 300 at the time of replacement are provided at both sides of the intermediate transfer device 300.

The second cleaning unit 109 removes waste toner remaining on the intermediate transfer device 105 after the toner image is transferred onto the printing medium S. As shown in FIG. 5, the second cleaning unit 109 includes a second blade 109a which scrapes the waste toner remaining on the surface of the intermediate transfer device 105 and a second transfer device 109b which transfers the waste toner towards a waste toner storage unit (not shown). The second transfer device 109b comprises a spiral shaped wing, and an auger which rotates in a predetermined direction to transfer the waste toner.

Referring back to FIG. 2, the control unit 500 prints an image corresponding to data of a desired image by controlling operations of respective elements of an image forming apparatus such as the first and second image forming units 100 and 400 and the light scanning unit 103. The control unit 500 controls operations of the first and second image forming units 100 and 400, so that, even when the first developing device 104 is not installed in the apparatus, an image may be printed in response to desired image data by an operation of the second image forming unit 400. Therefore, the control unit 500 controls the operations of the first and second image forming unit 100 and 400, so that, when only a mono-chromatic image is printed, the image may be printed regardless of the state of installation of the first image forming unit 100.

For example, when printing a color image, the control unit 500 operates the first and second image forming units 100 and 400, and, when printing a mono-chromatic image, the control unit 500 operates the second image forming unit 400. Therefore, even when the first developing device 104 is not installed, the control unit 500 prints an image by an operation of the second image forming unit 400.

According to an embodiment of the invention, the control unit 500 controls the operations of the first and second image forming units 100 and 400, so that a process speed ratio of the first and second image forming units 100 and 400 may be approximately 3:1. For example, the control unit 500 controls the operations of the first and second image forming units 100 and 400, so that the second photoconductor 401 rotates once to develop the black image, while the first photoconductor 101 rotates three times to superimposedly develop the cyan, magenta, and yellow images.

Further, the control unit 500 controls the operations of the first and second image forming units 100 and 400, so that the black toner image is transferred onto the intermediate transfer device 105, while any one of the cyan, magenta, and yellow toners are transferred onto the intermediate transfer device 105. At this time, the control unit 500 controls the operations of the first and second image forming units 100 and 400, so that the black toner image is transferred onto the intermediate transfer device 105, while the one of the cyan, magenta, and yellow toner images that is last transferred onto the intermediate transfer device 105, is transferred.

In another example, the control unit 500 controls the operations of the first and second image forming units 100 and 400, so that the printing speed of a mono-chromatic image print is approximately three times faster than that of a color image print.

Conventionally, the intermediate transfer device 105 rotates four times so that the cyan, magenta, yellow, and black images may be transferred onto the intermediate transfer device 105. However, according to aspects of the present invention, by superimposedly transferring the black toner image while transferring the last of the color toner images to the intermediate transfer device 105, the intermediate transfer device 105 is required to rotate only three times. Therefore, by controlling the first and second image forming units 100 and 400 in this manner, a color printing speed is improved.

The transfer roller 112 faces the surface to which the toner image of the intermediate transfer device 105 is transferred, and a transfer bias voltage is applied thereto so that the toner image transferred onto the intermediate transfer device 105 can be transferred onto the printing medium S. Thus, the toner image is transferred onto the printing medium S by the electrostatic force acting between the intermediate transfer device 105 and the transfer roller 112. The transfer roller 112 is separated from the intermediate transfer device 105 while the toner image is transferred onto the intermediate transfer device 105, and comes in contact with the intermediate transfer device 105 by a predetermined pressure to transfer the toner image onto the printing medium S after the toner image is completely transferred onto the intermediate transfer device 105. In addition, the toner image that is transferred onto the outer circumferential surface of the intermediate transfer device 105 may be transferred onto the printing medium S that passes between the transfer roller 112 and the intermediate transfer device 105 by contact pressure between the transfer roller 112 and the intermediate transfer device 105.

Before transferring the toner image on the first photoconductor 101 to the intermediate transfer device 105, a pre-transfer charge removing unit 110 removes an electric charge in a portion (non-image portion) where the toner image on the first photoconductor 101 is not formed. The pre-transfer charge removing unit 110 is disposed to improve an efficiency of the process of transferring the image from the first photoconductor 101 to the intermediate transfer device 105.

The charge removing lamp 107 is an example of a charge eliminating unit which removes an electric charge remaining on the outer circumferential surface of the first photoconductor 101 prior to a charging operation. The charge removing lamp 107 removes the electric charge remaining on the outer circumferential surface of the first photoconductor 101 by illuminating a constant amount of light onto the outer circumferential surface of the first photoconductor 101.

A power supply 108 provides a developing bias voltage to develop toner from the first and second developing devices 104 and 404 to the first and second photoconductors 101 and 401, an anti-developing bias voltage to prevent the toner from being attached from the first and second developing devices 104 and 404 to the first and second photoconductors 101 and 401, a transfer bias voltage to transfer the toner from the first and second photoconductors 101 and 401 to the intermediate transfer device 105, a transfer bias voltage to transfer the toner image from the intermediate transfer device 105 to the printing medium S, and a charging bias voltage provided to the charging roller 102.

A fusing unit 111 includes a heat roller 123 and a pressure roller 124 facing each other. The fusing unit 111 fuses the toner image onto the printing medium S by an application of heat and pressure. The heat roller 123 is a heat source to permanently fix the toner image and faces the pressure roller with respect to an axial direction thereof.

A discharge roller 117 discharges the printing medium S out of the image forming apparatus after printing is completed. The printing medium S, having been discharged, is loaded on an out-feed tray 180.

Reference numeral 113a denotes a feeding cassette, which is an example of a loading device, on which the printing medium S may be loaded. The loading device may further include a second feeding cassette 113b and a multi-purpose feeder (MPF) 113c. The MPF 113c is mainly used to allow for a transferring of a non-standard printing medium S.

A feed roller 116 feeds the printing medium S loaded out from feeding cassettes 113a, 113b, and 113c by the use of pickup rollers 115a, 115b, and 115c towards a feeding unit 120.

The feeding unit 120 provides a feeding path 121 placed between the feed roller 116 and the fusing unit 111 to guide the printing medium S and further provides for a duplex path 122 to allow for duplex printing operations. An arranging unit 118 is provided to the feeding unit 120. Before the printing medium S fed from the feed roller 116, the arranging unit 118 arranges a position of the printing medium S that passes between the intermediate transfer device 105 and the transfer roller 112, so that the toner image may be formed on a desired portion of the printing medium S. The printing medium S fed, as mentioned above, passes between the intermediate transfer device 105 and the transfer roller 112 and is then transferred onto the printing medium S. The printing medium S having been is subjected to the heat and pressure of the fusing unit 111, is then discharged out of the image forming apparatus 110 by the discharged roller 117.

During duplex printing operations, the discharge roller 117 reversely rotates, and the printing medium S is transferred along the duplex path 122. Here, the printing medium S is flipped over so that an image is printed on the surface where the image is not yet printed on. The flipped printing medium S is again fed through the feeding path 121 by the feed roller 116, and the image is printed on the other side thereof.

Hereinafter, operations of the image forming apparatus according to aspects of the present embodiment will be described.

Image data corresponding to cyan, magenta, yellow, and black is combined in color image data. When printing a color image, toner images of respective colors are superimposed to the intermediate transfer device 105 in the order of cyan C, magenta M, and yellow Y. When the last color is transferred to the intermediate transfer device 105, the black toner image is superimposed to the intermediate transfer device 105, and is then transferred to the printing medium S, thereby forming a color image.

On the other hand, when a light signal corresponding to cyan image data is illuminated onto the rotating first photoconductor 101 by the light scanning unit 03, the resistance of a light illuminated portion is reduced and an electric charge attached on the outer circumferential surface of the first photoconductor 101 is separated therefrom. As a result, an electric potential difference occurs between the light illuminated portion and the other portion, and an electrostatic latent image is thereby formed on the outer circumferential surface of the first photoconductor 101.

When the first photoconductor 101 rotates and the electrostatic latent image approaches the cyan developing unit 104C, the developing roller 125C of the cyan developing unit 104C starts to rotate. A development bias voltage is applied from the power supply 108 to the developing roller 125C of the cyan developing unit 104C. In addition, an anti-developing bias voltage to prevent a development is applied to the developing rollers 125M, 125Y, and 125K of other developing units 104M, 104Y, and 104K. Then, only the cyan toner passes across the development gap Dg and is attached on the electrostatic latent image formed on the outer circumferential surface of the first photoconductor 101, thereby forming a cyan toner image.

When the first photoconductor 101 rotates and the cyan toner image approaches the intermediate transfer device 105, the toner image is transferred to the intermediate transfer device 105 by the transfer bias voltage or contact pressure between the first photoconductor 101 and the intermediate transfer device 105.

After the cyan toner image is completely transferred to the intermediate transfer device 105, toner images of magenta and yellow are subject to the above mentioned operations and are transferred to the intermediate transfer device 105 and superimposed over the cyan image.

When the yellow image is transferred to the intermediate transfer device 105, a black image is subject to the above mentioned operations and is transferred from the second image forming unit 400 to the intermediate transfer device 105.

During the above-mentioned operations, the transfer roller 112 is separated from the intermediate transfer device 105. When all of the four toner images are transferred to the intermediate transfer device 105 and a color toner image is formed on the intermediate transfer device 105, the transfer roller 112 comes into contact with the intermediate transfer device 105 in order to transfer the color toner image onto the printing medium S.

By the time a front end of the color toner image formed on the intermediate transfer device 105 reaches a point where the intermediate transfer device 105 and the transfer roller 112 are in contact with each other, the printing medium S is supplied from the feeding cassette 113a (or 113b) or the MPT 113c, so that the frond end of the printing medium S reaches the point where the intermediate transfer device 105 and the transfer roller 112 are in contact with each other. When the printing medium S passes between the intermediate transfer device 105 and the transfer roller 112, the color toner image is transferred onto the printing medium S by the transfer bias voltage, is then fixed onto the printing medium S in the fusing unit 111 by applying heat and pressure, and is then discharged, thereby completing color image forming.

For the next printing operation to be undertaken, the second cleaning unit 109 removes the waste toner remaining on the intermediate transfer device 105.

In a common image forming apparatus in which developing materials of cyan, magenta, yellow, and black are provided in one developing unit, a color image is transferred to an intermediate transfer device after the intermediate transfer device rotates as many as four times. However, in the aforementioned image forming apparatus according to aspects of the present invention having the first developing device 104 and the second developing device 404, the black color in the second developing device 404 is transferred by the time when the last color in the first developing device 104 is transferred, so the color image is completely transferred to the intermediate transfer device 105 by the time the intermediate transfer device 105 has only rotated three times. Therefore, when printing a color image, the image forming apparatus according to an aspect of the present invention provides an improved printing speed than that of as in the conventional image forming apparatus. In addition, when printing a black and white image, only the second image forming unit 400 is used, so the printing speed is approximately three times faster than that of color printing.

According to aspects of the aforementioned configuration of the present invention, when printing a color image, the toner image is transferred onto a recording medium by operating the first and second image forming units 100 and 400, and when printing a black and white image, the toner image is transferred onto the recording medium by operating only the second image forming unit 400. At this time, the control unit 500 controls operations of each element. Meanwhile, the recording medium may be the intermediate transfer device 105 shown in FIGS. 2 to 5 or the printing medium S.

Accordingly, in an image forming apparatus and a printing method thereof according to aspects of the present invention, unlike as in the related art, an image forming unit to print a black and white image and an image forming unit to print a color image are separately configured, so that when printing a black and white image, one image forming unit is operated, whereas when printing a color image, two image forming units are operated. By this configuration in which two image forming units are separated from the image forming apparatus, compatibility between a color model apparatus and a mono-chromatic (black and white) model apparatus is improved. In addition, in comparison to a conventional multi-path type image forming apparatus in which a speed rate of color printing and black and white printing is 1:4, the present invention provides the printing speed rate of 1:3. In addition, when printing only a mono-chromatic (black and white) image, a user may purchase a model having only one image forming unit, resulting in increasing a user's convenience and saving purchase cost. In addition, the user may additionally purchase a color image forming unit, if needed, to be later incorporated into the image forming apparatus, thereby forming a color image forming apparatus. Namely, various forms of image forming apparatus may be provided with one image forming apparatus.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image forming apparatus, comprising:
a first image forming unit, including a first photoconductor and a first developing device that develops an image by supplying toner onto an electrostatic latent image formed on the first photoconductor;
a second image forming unit, including a second photoconductor and a second developing device that develops an image by supplying toner onto an electrostatic latent image formed on the second photoconductor; and
a control unit to control operations of the second image forming unit, so that, when the first image forming unit is not installed in the image forming apparatus, the image is printed in response to desired image data by an operation of the second image forming unit.

2. The image forming apparatus according to claim 1, wherein the first developing device comprises a plurality of developing units in which toner to develop a color image is stored.

3. The image forming apparatus according to claim 2, wherein the second developing device comprises a developing unit in which black toner to develop a mono-chromatic image is stored.

4. The image forming apparatus according to claim 1, wherein the first developing device comprises three developing units to store cyan, magenta, and yellow toner, and the second developing device comprises a developing unit to store black toner, the second developing device being detachably disposed in the second image forming unit, irrespective of an installation state of the first developing device.

5. The image forming apparatus according to claim 1, further comprising first and second transfer units which face the first and second photoconductors in opposite directions with respect to the first and second developing devices, respectively.

6. The image forming apparatus according to claim 1, further comprising a light scanning unit to form the electrostatic latent image onto outer circumferential surfaces of the first and second photoconductors by illuminating light corresponding to image data onto the surfaces of the first and second photoconductors in response to a computer signal.

7. The image forming apparatus according to claim 1, further comprising an intermediate transfer device which faces the first and second photoconductors and to which a toner image developed onto the first and second photoconductors is transferred.

8. The image forming apparatus according to claim 1, wherein the first and second image forming units are disposed such that the toner image developed onto the first and second photoconductors is transferred onto a printing medium that is transferred along a predetermined path.

9. An image forming apparatus comprising:
a first image forming unit, including a first photoconductor and a first developing device that develops an image by supplying a toner onto an electrostatic latent image formed on the first photoconductor;
a second image forming unit, including a second photoconductor and a second developing device that develops an image by supplying a toner onto an electrostatic latent image formed on the second photoconductor; and
a control unit to control operations of the first and second image forming units, so that a process speed ratio of the first and second image forming units is approximately 3:1.

10. The image forming apparatus according to claim 9, wherein the control unit controls the operations of the first and second image forming units, so that a printing speed of a mono-chromatic image is approximately three times faster than a printing speed of a color image.

11. The image forming apparatus according to claim 9, wherein the first developing device comprises three developing units to store cyan, magenta, and yellow toner, and the second developing device comprises a developing unit to store black toner, the second developing device being detachably disposed in the second image forming unit, irrespective of an installation state of the first developing device.

12. The image forming apparatus according to claim 11, wherein the control unit controls the operations of the first and second image forming units, so that a black toner image is transferable onto an intermediate transfer device, while any one of toner images of cyan, magenta, and yellow are transferred onto the intermediate transfer device.

13. The image forming apparatus according to claim 11, wherein the first image forming unit and the second image forming unit are structured to allow the second photoconductor to rotate once to develop a black image, while the first photoconductor rotates three times to develop cyan, magenta, and yellow images.

14. A printing method to operate an image forming apparatus having a first image forming unit which includes a first developing device developing a color image by supplying a toner onto the first photoconductor and a second image forming unit which includes a second developing device developing a mono-chromatic image by supplying a black toner onto the second photoconductor; wherein, when printing the color image, the method comprises transferring a toner image onto a recording medium by an operation of the first and second image forming units, whereas when printing the mono-chromatic image, the method comprises transferring the toner image onto the recording medium by operating the second image forming unit, even when the first image forming unit is not installed.

15. The printing method according to claim 14, wherein the recording medium is a printing medium.

16. The printing method according to claim 14, wherein the recording medium is an intermediate transfer device.

17. A printing method to operate an image forming apparatus having a first image forming unit which includes a first developing device developing a color image by supplying a toner onto the first photoconductor and a second image forming unit which includes a second developing device developing a mono image by supplying a black toner onto the second photoconductor; wherein a process speed ratio of the first and second image forming units is approximately 3:1.

18. The printing method according to claim 17, wherein the operations of the first and second image forming units are controlled so that a printing speed of a mono-chromatic image is approximately three times faster than a printing speed of a color image.

19. The printing method according to claim 17, wherein the first developing device comprises three developing units to store cyan, magenta, and yellow toners, and the second developing device comprises a developing unit to store black toner, the second developing device being detachably disposed in the second image forming unit, irrespective of an installation state of the first developing device.

20. The printing method according to claim 19, wherein the first image forming unit and the second image forming unit are structured such that the second photoconductor rotates once to develop a black image, while the first photoconductor rotate three times to develop cyan, magenta, and yellow images.

21. An image forming apparatus to print a color and/or a mono-chromatic image, comprising:
a first photoconductor on which a first electrostatic latent image, on which the color image is based, is formed;
a first developing device to develop the color image by supplying colored toner onto the first electrostatic latent image;
a second photoconductor on which a second electrostatic latent image, on which the mono-chromatic image is based, is formed;
a second developing device to develop the mono-chromatic image by supplying black toner onto the second electrostatic latent image; and
a control unit to control the second photoconductor and the second developing device, so that, when at least one of the first photoconductor and the first developing device is not installed in the image forming apparatus, the color image is printed as the mono-chromatic image by the second image forming unit.

22. The image forming apparatus according to claim 21, wherein the first developing device comprises a plurality of developing units in which toner to develop a color image is stored.

23. The image forming apparatus according to claim 21, wherein the second developing device comprises a developing unit in which black toner to develop a mono-chromatic image is stored.

24. The image forming apparatus according to claim 21, wherein the first developing device comprises three developing units to store cyan, magenta, and yellow toner, and the second developing device comprises a developing unit to store black toner, the second developing device being detachably disposed in the second image forming unit, irrespective of an installation state of the first developing device.

25. The image forming apparatus according to claim 21, further comprising first and second transfer units which face the first and second photoconductors in opposite directions with respect to the first and second developing devices, respectively.

26. The image forming apparatus according to claim 21, further comprising a light scanning unit to form the first and second electrostatic latent images onto outer circumferential surfaces of the first and second photoconductors by illuminating light corresponding to image data onto the surfaces of the first and second photoconductors in response to a computer signal.

27. The image forming apparatus according to claim 21, further comprising an intermediate transfer device which faces the first and second photoconductors and to which a toner image developed onto the first and second photoconductors is transferred.

28. An image forming apparatus to print a color and/or a mono-chromatic image, comprising:
a first photoconductor on which a first electrostatic latent image, on which the color image is based, is formed;
a first developing device to develop the color image by supplying colored toner onto the first electrostatic latent image;
a second photoconductor on which a second electrostatic latent image, on which the mono-chromatic image is based, is formed;
a second developing device to develop the mono-chromatic image by supplying black toner onto the second electrostatic latent image; and
a control unit to operate the first and second photoconductors and the first and second developing devices, so that a process speed ratio of the first and second photoconductors and the first and second developing devices is approximately 3:1.

29. The image forming apparatus according to claim 28, wherein the control unit controls the operations of the first and second photoconductors and the first and second developing devices, so that a printing speed of a mono-chromatic image is approximately three times faster than a printing speed of a color image.

30. The image forming apparatus according to claim 28, wherein the first developing device comprises three developing units to store cyan, magenta, and yellow toner, and the second developing device comprises a developing unit to store black toner, the second developing device being detachably disposed in the second image forming unit, irrespective of an installation state of the first developing device.

31. The image forming apparatus according to claim 30, wherein the control unit controls the operations of e first and second photoconductors and the first and second developing devices, so that a black toner image is transferable onto an intermediate transfer device, while any one of toner images of cyan, magenta, and yellow are transferred onto the intermediate transfer device.

32. The image forming apparatus according to claim 31, wherein the first and second photoconductors and the first and second developing devices are structured to allow the second photoconductor to rotate once to develop a black image, while the first photoconductor rotates three times to develop cyan, magenta, and yellow images.

33. An image forming apparatus to print a mono-chromatic image or a color image, comprising:
a photoconductor on which an electrostatic latent image, on which the mono-chromatic image and the color image are based, is formed;
a developing device to develop the mono-chromatic image by supplying black toner onto the electrostatic latent image; and
a control unit to control the developing device, so that, when the color image is to be printed, the color image is developed by the developing device in the same manner as that of the mono-chromatic image.
